(19) United States
(12) Patent Application Publication
(10) Pub. No.: US 2005/0057913 A1
(43) Pub. Date: Mar. 17, 2005

(54) Backlight having multiple intensity maxima

(76) Inventor: Brett M. Dennis, St. Paul, MN (US)

Correspondence Address: 3M INNOVATIVE PROPERTIES COMPANY, PO BOX 33427, ST. PAUL, MN, 55133-3427, US

(21) Appl. No.: 10/663,936

(22) Filed: Sep. 16, 2003

(51) Int. Cl. G01D 11/28

(52) U.S. Cl. 362/26

(57) ABSTRACT

A backlight includes a source of diffuse light and a light transmissive film having a structured surface facing the light source where the film directs light from the light source into a plurality of primary intensity lobes in different directions.

### FIELD OF THE INVENTION

The present invention relates to backlights for use with electronic displays and more particularly to backlights having major, maximum output lobes in a plurality of directions.

### BACKGROUND

Many electronic displays utilize a light valve that is illuminated by a backlight. The most common type of light valve currently in use is the liquid crystal display (“LCD”). Back lit LCD's are familiar to almost any user of electronic devices ranging from wristwatches to laptop computers.

In order to optimize the efficiency of backlights, a variety of film materials are used. Among the films used are a variety of brightness enhancing films. The need for brightness enhancing materials is increased by the fact that typical LCD's absorb 90 to 94% of the light that impinges on them.

Since LCD's necessarily operate on polarized light, and an absorbing polarizer inherently absorbs and discards at least half of the light impinging on it, many backlights utilize a reflective polarizer that transmits one polarization of light and reflects the other. The light that is reflected will either have its polarization reversed or randomized. In either case the light is reflected back to the reflective polarizer allowing more of the light to be transmitted. Backlights that use reflective polarizers in this way are characterized as polarization recycling backlights.

Another type of backlight utilizes directional recycling films. A backlight that utilizes a directional recycling film is known as a directionally recycling backlight. It is possible for a backlight to be both directional and polarization recycling by using both types of materials.

FIG. 1 shows a display 10 utilizing a directionally recycling backlight. In display 10, a lamp 12, such as a cold cathode fluorescent tube, directs light into an input surface 14 of light guide 16. A reflector 18 behind lamp 12 helps to direct the light into light guide 16. Light is conducted along light guide 16 by total internal reflection from surfaces 20 and 22 of light guide 16. Light may be extracted from light guide 16 in a variety of manners. The most common manner is by providing a series of small dots 24 on the back or bottom surface of light guide 16. Typically dots 24 are screen-printed of a white, highly diffuse material in order to provide color independent and diffuse reflection. Typically also, the density of dots 24 increases along the course of the light guide. Thus, the density of the dots will be greater closer to end 26 of light guide 16 than it will be close to input end 14. This helps to increase the uniformity of light extraction from light guide 16.

Light extracted through side 20 of light guide 16 encounters diffuser 28. Diffuser 28 serves to further randomize the direction of the light as well as to hide dots 24 which would otherwise appear to a viewer of the display as bright spots. After diffuser 28, light enters directional recycling film 30. Directional recycling film 30 could be of a variety of forms but typically has a plurality of prisms thereon. One type of directional recycling film that may be used and the function of such directional recycling films is described in U.S. Pat. No. 6,354,709, the teaching of which is incorporated herein by reference. The effect of directional recycling film 30 is to reflect light which is traveling in directions closer to the axis of the display back toward light guide 16 while refracting light traveling in directions further from the axis of the display towards the axis of display. Thus, the light emerging from direction recycling film 30 does so in a smaller range of angles than the light entering directional recycling film 30. Thus, directional recycling 30 collapses the light traveling through it into a smaller range of angles in the dimension perpendicular to the prisms.

Typically a second directional recycling film 34 is also used. The prisms 36 on directional recycling film 34 cannot be directly seen in FIG. 1 because they run in a direction perpendicular to lamp 12 but are indicated by dashed line 38. Directional recycling film 34 works like directional recycling film 30 except in a direction perpendicular to the direction in which directional recycling film 30 operates. The light reflected by directional recycling films 30 and 34 pass back through diffuser 28, light guide 16 and strike reflector 40. In addition, light emitted through side 22 of light guide 16 also strikes reflector 40. Reflector 40 could be either a highly reflective diffuse reflector or a specular reflector such as Enhanced Specular Reflector (“ESR”) available from 3M Company. After being reflected by reflector 40, the light passes back through light guide 16 and diffuser 28 and enters directional recycling film 30. Since the direction of the light has now been randomized by two passes through diffuser 28, as well as reflection from reflector 40 if reflector 40 is a diffuse reflector, the light now makes a wide variety of angles with directional recycling film 30 and the operation of directional recycling films 30 and 34 are repeated.

The result of the operation of the backlight that includes light guide 16, diffuser 28, directional recycling films 30 and 34 is that the light entering liquid crystal display panel 42 has a much narrower range of angles than the light initially emitted through surface 20 of light guide 16. This narrow range of angles is concentrated on the axis of the display, the direction most useful to a viewer. This permits the designer of the display to obtain a desired on-axis brightness while using a smaller output lamp than would otherwise be required.

FIG. 2 is a graph showing the amount of illumination provided by a display of the type shown in FIG. 1 as a function of the angle from which the display is viewed. In FIG. 2 an angle of 0° corresponds to an observer viewing the display from directly in front of it and increasing positive and negative angles correspond to viewing from increasing angles. As may be seen from FIG. 2, the on-axis apparent brightness is greatest on the display axis or normal to the display surface. Because of its shape and size, the central portion of the graph is known as the major or primary lobe. Outside of the central primary lobe 50, the apparent brightness drops off significantly until, at fairly large angles, it will typically rise again. The smaller maxima 52 and 54 that occur at large angles are known as the minor or secondary lobes. Although there is no reason to desire such secondary lobes, they typically result from the operation of the directional recycling films. Alternatively phrased, the backlight of FIG. 1 has a single major peak in gain which occurs on the display axis.

Another type of film that is used to help provide high on-axis brightness in a backlit display is known as turning film. FIG. 3 shows a display 60 that utilizes a turning film. In display 60, a lamp 62 emits light such as light beam 64 which enters a light guide 66 through input surface 68. Light is conducted through light guide 66 by total internal reflection from surfaces 70 and 72.

As may be seen, light guide 66 takes the form of a wedge. This means that surfaces 70 and 72 are not parallel to one another as they were in the slablike guide 16 of FIG. 1. As light is reflected from the surfaces, it continues to make smaller and smaller angles to the normals to the surfaces. Eventually, light ray 64 will strike a surface at an angle that is no longer greater than the critical angle. For light ray 64, this occurs at point 74 on surface 70. Since light ray 64 strikes surface 70 at an angle less than the critical angle, it is not totally internally reflected and passes through surface 70. When light ray 64 passes through surface 70, it is refracted to an angle highly oblique to the normal to surface 70.

Since all of the extraction occurs when the various light rays reach angles that are less than the critical angle, they tend to all be extracted when traveling at approximately the same angle. Thus, the light emitted from light guide 66 tends to be highly collimated, but collimated in a direction itself highly oblique to the normal to surface 70, which corresponds to the axis of the display. Light ray 64 then encounters turning film 76. Turning film 76 has a plurality of linear prisms such as prism 78. Prism 78 has input surface 80 and reflecting surface 82. Light ray 64 enters a prism such as prism 78 through entry surface 80 and is reflected by reflecting surface 82. After reflection by reflecting surface 82, the light is turned to a direction highly collimated along the axis of the display. It then passes through liquid crystal display panel 84.

In addition to the features described above, display 60 will typically include a reflector 86 for recovering light that escapes through surface 72 of light guide 66. Furthermore, although not necessary in theory, light extraction from light guide 66 may be enhanced through the use of screen printed dots such as dots 24 of the display of FIG. 1, diffusing structures on surface 70 or 72 or bulk diffusing materials embedded in light guide 66.

FIG. 4 is a plot of the light intensity of a backlight according to FIG. 3 as a function of viewing angle. As may be seen, the light intensity has a strong maximum or major or primary lobe 90 on the display axis. Typically turning film based systems do not exhibit secondary lobes unless they are used in conjunction with a directional recycling film, whose prisms would be typically directed in a direction perpendicular to the prisms of the turning film.

The displays described above provide strong maximum output on axis. This is typically desirable because a viewer will normally look at the display along the display axis. Sometimes, however, a display is intended to be viewed by a plurality of people at one time. Heretofore, designers of displays have provided a strong primary lobe and accepted that as two or more viewers look at the display none, or at most one, will be viewing the display from the direction of the primary lobe. A preferred design would provide a plurality of primary lobes, one for each intended viewer.

### SUMMARY

According to the invention, a backlight includes a source of diffuse light. Light from the light source enters a light transmissive film having a structured surface facing the light source. The film directs light from the light source into a plurality of primary intensity lobes in different directions

### BRIEF DESCRIPTION OF THE DRAWINGS

FIG. 1 is a side view of a display using a backlight of the prior art;

FIG. 2 is a graph of the light output of a backlight according to FIG. 1;

FIG. 3 is a side view of a display using another backlight of the prior art;

FIG. 4 is a graph of the light output of a backlight according to FIG. 3;

FIG. 5 is a side view of a display using a backlight according to one embodiment of the invention;

FIG. 6 is a graph of the light output of a backlight according to FIG. 5;

FIG. 7 is a side view of a display using another embodiment of the invention;

FIG. 7A is a top view of the backlight according to FIG. 7;

FIG. 8 is a side view of a display using another embodiment of the invention;

FIG. 9 is a side view of a display using another embodiment of the invention;

FIG. 10 is a side view of a display using another embodiment of the invention; and

FIG. 11 is a side view of another film that may be used in the invention.

### DETAILED DESCRIPTION

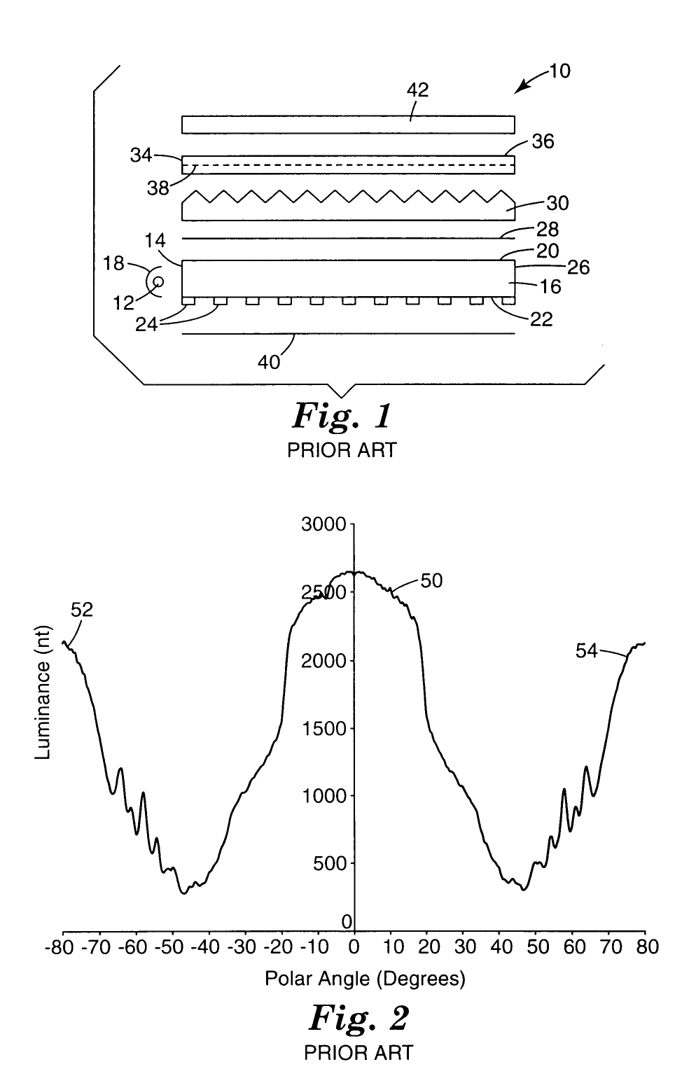

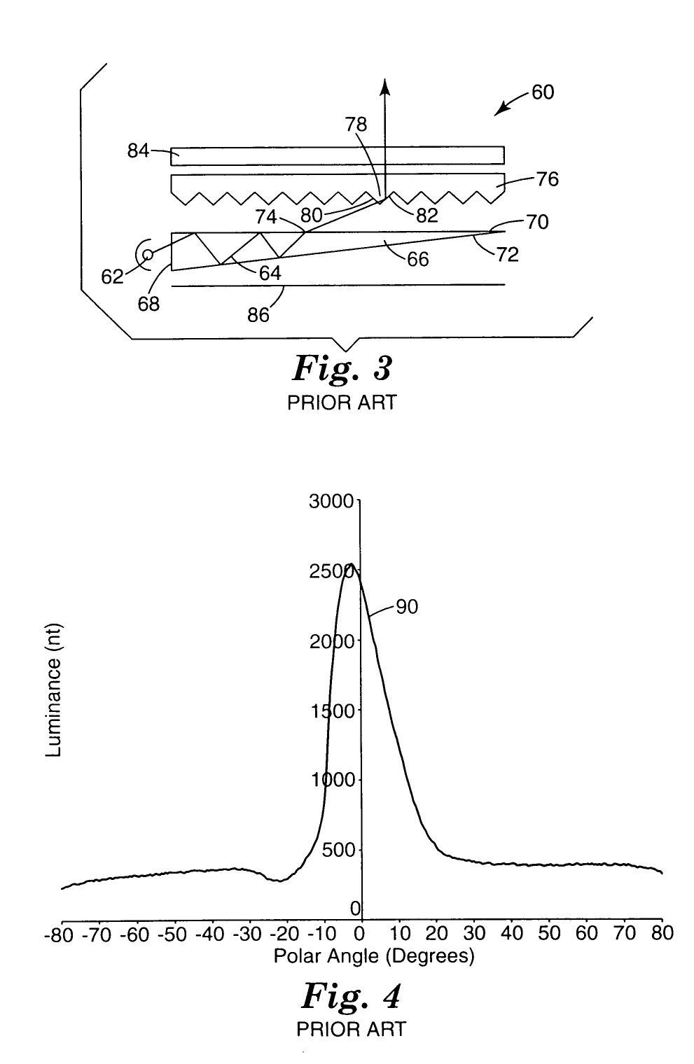

As described above, a backlight according to FIG. 1 will operate with either a diffuse or a directional source of light. The system of FIG. 3, on the other hand, uses a highly directional source of light. In each of the systems of FIGS. 1 and 3, the resulting light output has a single principle node on the axis of the display. The present invention utilizes a light directing film with a diffuse light source in order to provide a plurality of major lobes in the output distribution. Preferably the light source is a lambertian source, although, in general, any diffuse light source will suffice.

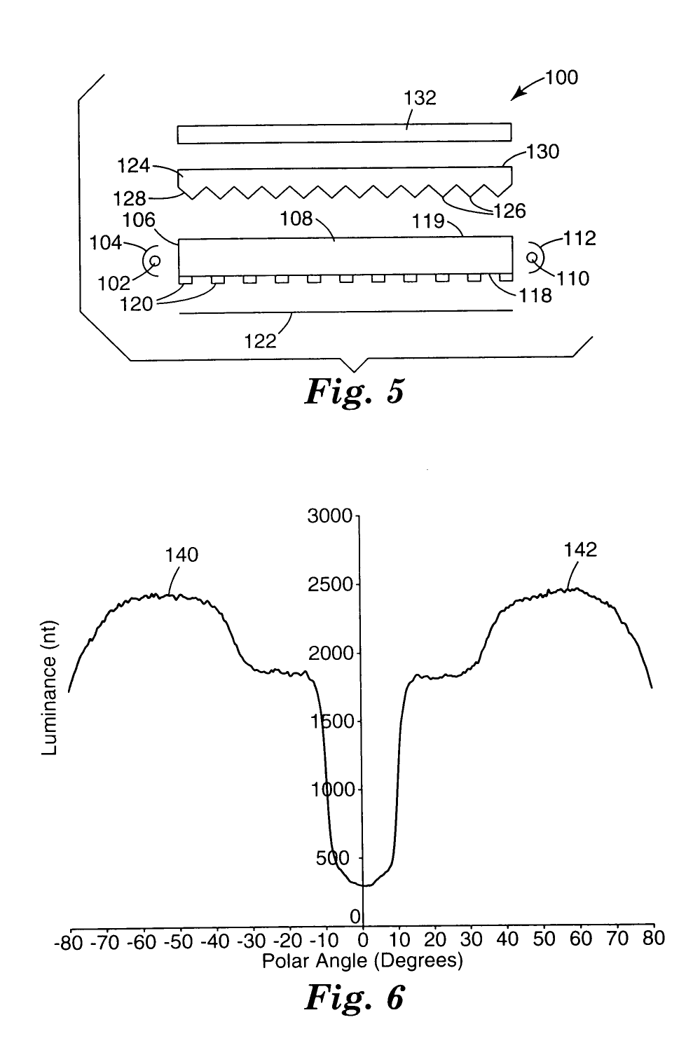

FIG. 5 shows a backlight display 100 according to the present invention. Backlit display 100 includes a lamp 102 which works in cooperation with a reflector 104 to provide light to input surface 106 of light guide 108. An optional additional lamp 110 operates in conjunction with reflector 112 to provide light to second input surface 114 of light guide 108. In the embodiment shown in FIG. 5, input surfaces 106 and 114 are parallel to one another. Both lamps 102 and 110 are preferably cold cathode fluorescent tubes. Light guide 108 conducts light from lamps 102 and 110 of total internal reflection from surfaces 118 and 119. Light guide 108 also includes a diffuse extraction mechanism. Typically a diffuse extraction mechanism is provided in the form of diffusely reflecting, screen printed dots 120. Light traveling in light guide 108 will strike one of dots 120 and be diffusely reflected and extracted from light guide 108. A reflector 122 is provided behind light guide 108, although it is less important than reflectors 40 and 86 of FIGS. 1 and 3 respectively because the backlight of FIG. 5 is not recycling and is unlikely to extract a significant amount of light through back surface 118.

Extracted light emerges from light guide 108 through front surface 119 and enters light directing film 124. Light directing film 124 is light transmissive and has structures 126 on the side adjacent light guide 108. Structures 126 may have a variety of shapes. In one embodiment, structures 126 are triangular prisms. Structures 126 of light directing film 124 may have the shape of isosceles triangles with 90 degree included angles. The product BEF II 90/50, commercially available from 3M Company, works well as a light directing film according to the present invention. If BEF II 90/50 is used as a light directing film, it should be installed upside down from the way in which it is normally installed.

In operation structures 126 on side 128 of light directing film 124 operate by way of refraction to separate the light into two principle output lobes. The angular location and strength of those lobes will depend on the output distribution of light guide 108, geometry of structures 126 and the index of refraction of light directing film 124. The light emerges through surface 130 of light directing film 124. Surface 130 of light directing film 124 may be an optically smooth surface or may have a matte finish or other optically functional structure. After emerging from light directing film 124, the light passes through LCD panel 132.

FIG. 6 shows a graph of light output as a function of viewing angle for a display according to FIG. 5. The data for FIG. 6 came from a backlight having highly diffuse output and using BEF II 90/50 as a light directing film. BEF II 90/50 has right isosceles prisms having a peak to peak pitch of 50 μm. It is made of an acrylate resin having an index of refraction of 1.586 cast on a polyester substrate. As may be seen the light has two principle output lobes at approximately plus and minus 45 degrees.

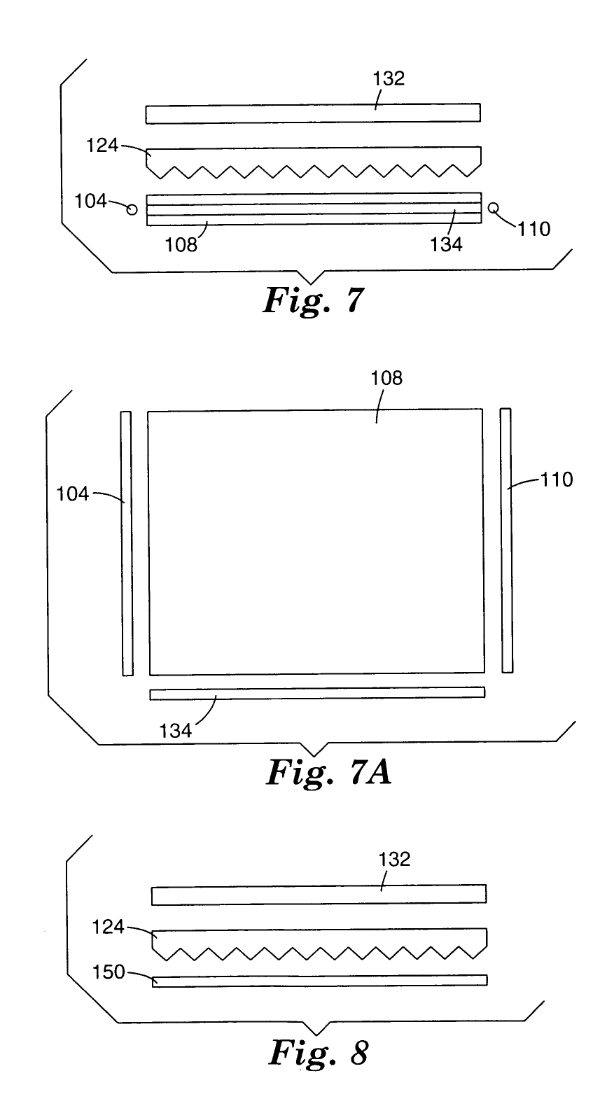

FIG. 7 shows an embodiment of the display system of FIG. 5 including lamps 104, 110 and an additional lamp 134. This arrangement is sometimes referred to as a “U” lamp arrangement since lamps are provided on three sides of the light guide. FIG. 7A is a top view of light guide 108 and lamps 194, 110, and 134 for clarity. Alternatively a “L” arrangement could be used by providing lamps on 2 adjacent sides of light guide 108. Thus, for example, an “L” arrangement could include lamps 104 and 134 but not lamp 110.

Although the examples given with respect to FIGS. 5, 6 and 7 include cold cathode fluorescent tubes, other lamps may be used as well. For example, light guide 108 may be eliminated all together and replaced with an electroluminescent panel. Generally electroluminescent panels provide highly diffuse outputs that would work very well with the present invention.

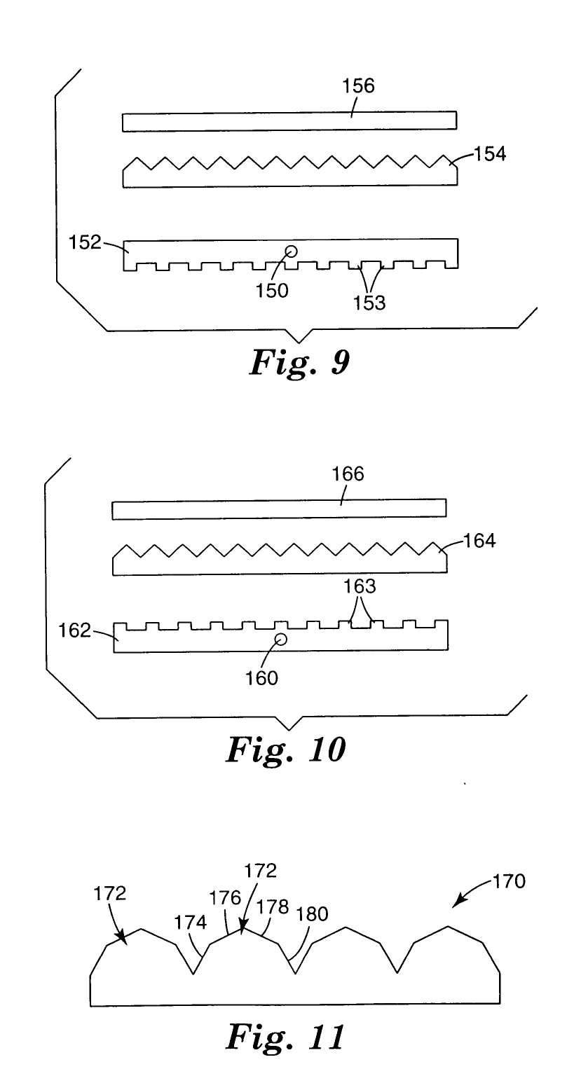

Another type of lamp that can be used with the present invention is an LED. In fact, one or more LED's could be used with the present invention. When an LED is used, it is typically desirable to provide some system for helping to evenly distribute the light in the light guide and to extract the light from the light guide. This could be a reflective structure, typically operating by total internal reflection. Such structures are described in U.S. Pat. No. 6,167,182, the disclosure of which is incorporated herein by reference. FIG. 9 shows a light guide using such reflective structures. According to the system of FIG. 9 and LED 150, emits light into light guide 152. Reflective structures 153 help to distribute the light evenly in light guide 152 and to extract light from light guide 152. Typically such reflective structures will be positioned on the back of light guide 152. After exiting from light guide 152, the light encounters direction control film 154 which divides the light into two primary lobes. Finally, the light is modulated by LCD panel 156.

As an alternative to the reflective technology described in conjunction with FIG. 9, diffractive technology may be used. In a diffractive light guide, diffractive rather than reflective structures help to provide uniform light distribution in the light guide and extract light from the guide. European published patent application 1,016,817 A1, the disclosure of which is incorporated herein by reference, describes such a diffractive light guide. FIG. 10 shows a display including a diffractive light guide. Light from a LED 160 goes into light guide 162. Light guide 162 includes diffractive structures 163. Typically diffractive structures 163 are positioned on the front surface of light guide 162, but in some circumstances could be on the back surface or even on both surfaces. Diffractive structures 163 help to provide uniform illumination of the light guide and extract the light from the light guide. After extraction from the light guide, the light encounters direction control film 164, which separates it into two major lobes. Finally, the light is modulated by LCD panel 166.

All of the embodiments shown and discussed utilize light directing films having isosceles prisms. Such prisms are generally desirable when symmetric positioning of the major lobes are required. However, other designs could be utilized. For example, asymmetric prisms could be used if it is desirable to have the major lobes positioned asymmetrically with respect to a normal to the light directing film. Such a configuration might be desirable, for example, in a navigation display in an automobile if that display is to be positioned in a location other than in the center of the dashboard. This would allow the major lobes to be located for easy reading by both the driver and the front seat passenger.

Shapes other than triangular prisms may also be used. Such shapes would generally be desirable when more than two lobes are desired. FIG. 11 shows a prism film 170 having prisms 172. Each of prisms 172 has four active faces 174, 176, 178, and 180. Such a film would provide four distinct principle lobes. Other designs are certainly possible as may be desirable for a particular display.

1. A backlight comprising:
a source of diffuse light; and
a light transmissive film having a structured surface, said structured surface being on a side of said film facing said source of diffuse light such that said film directs light from said source of diffuse light into a plurality of primary intensity lobes in different directions.

2. The backlight of claim 1 wherein said light source includes a light guide.

3. The backlight of claim 2 wherein said light guide has the form of a slab.

4. The backlight of claim 1 wherein said light guide has a first input surface.

5. The backlight of claim 4 wherein said light source further includes a first cold cathode fluorescent tube adjacent said first input surface.

6. The backlight of claim 5 wherein said light guide further includes a second input surface and said light source further includes a second cold cathode fluorescent tube adjacent said second input surface.

7. The backlight of claim 6 wherein said second input surface is adjacent said first input surface.

8. The backlight of claim 6 wherein said second input surface is parallel to said first input surface.

9. The backlight of claim 6 wherein said light guide further includes a third input surface and said light source further includes a third cold cathode fluorescent tube adjacent said third input surface.

10. The backlight of claim 2 wherein said light guide has the form of a wedge.

11. The backlight of claim 2 wherein said light source further includes a light emitting diode.

12. The backlight of claim 1 wherein said light source includes an electroluminescent panel.

13. The backlight of claim 1 wherein said film directs light into two primary intensity lobes.

14. The backlight of claim 1 wherein said film directs light into four primary intensity lobes.

15. The backlight of claim 1 wherein said structured surface has triangular prisms thereon.

16. The backlight of claim 15 wherein said triangular prisms have the shape of isosceles triangles.

17. The backlight of claim 16 wherein said prisms are right isosceles prisms.

18. An electronic display comprising
a source of diffuse light;
a film having a structured surface, said structured surface being on a side of said film opposite of said source of diffuse light such that said film directs light from said source of diffuse light into a plurality of primary intensity lobes in different directions; and
a light valve.

19. The electronic display of claim 18 wherein said light valve is a liquid crystal display.
